(19) United States
(12) Patent Application Publication
(10) Pub. No.: US 2026/0073282 A1
(43) Pub. Date: Mar. 12, 2026

(54) SERVICE FEASIBILITY ASSESSMENT AND MONITORING FOR INITIAL AI MODEL HANDLING

(71) Applicant: HUAWEI TECHNOLOGIES CO., LTD., Shenzhen (CN)

(72) Inventors: Hesham Gamal Aly Mohamed MOUSSA, Ottawa (CA); Mehdi Arashmid AKHAVAIN MOHAMMADI, Ottawa (CA)

(21) Appl. No.: 18/829,777

(22) Filed: Sep. 10, 2024

(51) Int. Cl. G06N 20/00

(52) U.S. Cl. CPC G06N 20/00

(57) ABSTRACT

Embodiments of the present application provide a method, apparatus, and computer readable medium for evaluating service feasibility of AI models training on a global dataset. At least one AI model, data requirements for the AI model, and a target training accuracy performance indicator for the AI model when trained are received from a user. Relevant data is determined from a global dataset, the relevant data is based on the received data requirements. A training accuracy estimation module is used to calculate a model score for the AI model based on the relevant data, the model score representing an estimated training accuracy to which the AI model can be trained. Based on the model score, it is determined whether the target training accuracy performance indicator can be satisfied. When the target training accuracy performance indicator can be satisfied, the at least one AI model is communicated to a model training environment.

### TECHNICAL FIELD

The present application relates generally to artificial intelligence (AI) model handling and specifically to a service feasibility assessment and monitoring prior to training the AI model.

### BACKGROUND

Admission control is a well-known concept in various fields, including wireless communication, mobile networks, cloud systems and computer systems. The general idea behind admission control is the same. That is, given available resources and an incoming request for service, admission control determines whether the incoming request should be serviced or if it should be denied service.

For example, admission control in cloud environments provides a mechanism for clients to submit their service requests based on their budget and requirements. Typically, the requirements include physical resources such as amount of compute, storage, link budget, bandwidth, and the like. Using these attributes, a cloud operator can assess and determine whether the service requests can be satisfied. If so, the cloud operator allocates the necessary resources to render the service.

However, admission control cannot readily be used for Artificial Intelligence (AI) model training. For example, for AI model training, even significant resources in terms of compute, storage, and bandwidth, do not provide good indicators that the AI model should be trained.

### SUMMARY

In accordance with an aspect of an embodiment, there is provided a method for evaluating service feasibility of AI models training on a global dataset. The method comprises receiving at least one AI model, data requirements for the AI model, and a target training accuracy performance indicator for the AI model when trained. Relevant data is determined from a global dataset, the relevant data based on the received data requirements. A training accuracy estimation module is used to calculate a model score for the AI model based on the relevant data, the model score representing an estimated training accuracy to which the AI model can be trained. Based on the model score, it is determined whether the target training accuracy performance indicator can be satisfied. When the target training accuracy performance indicator can be satisfied, the at least one AI model is communicated to a model training environment.

In some implementations, when the target training accuracy performance indicator cannot be satisfied, information from the model training environment may be analysed. Based on the analysis, suggested modifications to the AI model may be generated to improve the likelihood that the target training accuracy performance indicator can be satisfied.

In some implementations, when the target training accuracy performance indicator cannot be satisfied, the method may further comprise waiting an amount of time; retrieving the relevant data, wherein the relevant data has been updated; using the training accuracy estimation module to re-process the one or more AI models based on the retrieved, updated relevant data to calculate a new model score; determining, based on the new model score, where the target training accuracy performance indicator can be satisfied; and communicating the at least one AI models to the model training environment when the target training accuracy performance indicator can be satisfied.

In some implementations, when the target training accuracy performance indicator cannot be satisfied, the method may further comprise identifying at least one parameter likely to improve the accuracy to which the AI model can be trained; in response to the identified parameter being updated, retrieving the relevant data, wherein the relevant data includes the updated parameter; using the training accuracy estimation module to reprocess the AI model based on the retrieved, updated relevant data to calculate a new model score; determining, based on the new model score, whether the target training accuracy performance indicator can be satisfied; and communicating the AI model to the model training environment when the target training accuracy performance indicator can be satisfied.

In some implementations, when the target training accuracy performance indicator can be satisfied, the method may further comprise monitoring at least one parameter likely to affect the performance of the AI model; and in response to determining the at least one parameter affects performance of the AI model beyond a predefined performance threshold, re-training the AI model. The at least one defined parameter may be monitored automatically or updated in response to a user inquiry to determine if it affects operation of the AI model beyond the predefined performance threshold.

In some implementations, when the target training accuracy performance indicator can be satisfied, the method may further comprise determining whether a model engine queue is experiencing storage and/or processing constraints, the model engine queue configured to queue AI models before entry to the model training environment; and regulating communication of the AI model to the model engine queue if the model engine queue is experiencing storage and/or processing constraints.

In some implementations, the method may further comprise prioritizing access to the model training environment for different ones of the one or more AI models.

In some implementations, the training accuracy estimator may comprise a zero-cost proxy. The method may further comprise providing the AI model to the zero-cost proxy for calculating the model score using the relevant data from the global dataset.

In some implementations, the relevant data may include the entire global dataset or a portion of the global dataset. The relevant data may include the actual data from the global dataset or a representation of the actual data from the global dataset. The representation of the actual data may include anonymized data. The representation of the actual data may include synthetic data. The synthetic data may include new datasets that mirror the structure and properties of the actual data retrieved from the global dataset.

In accordance with another aspect of an embodiment, there is provided an apparatus for admission control of AI models for training. The apparatus comprises one or more processors; and a non-transitory computer readable medium having stored thereon instructions which. The instructions, when executed by the one or more processors, cause the apparatus to implement the method described above.

In some implementations, the service-feasibility may be determined using a centralized architecture.

In some implementations, the service feasibility may be determined using a distributed architecture. In such an architecture, some of the features of the method described above may be implemented on each of a plurality of data nodes in the model training environment. Each data node may provide a node model score. The model score may comprise a combination of the node model scores.

In some implementations, the apparatus may be a component in a service-based architecture for deploying AI-based components within a network.

In accordance with another aspect of an embodiment, there is provided a non-transitory computer-readable medium having stored thereon instructions which, when executed by one or more processors, cause an apparatus to implement the method described above.

### BRIEF DESCRIPTION OF THE DRAWINGS

Embodiments will now be described by way of example only with reference to the following drawings in which:

FIG. 1 is a schematic drawing of a service-feasibility assessment system;

FIG. 2 is a block diagram of a service-feasibility assessment module (S-FAM);

FIG. 3 is a flowchart describing operation of the S-FAM;

FIG. 4 is a flowchart describing further operation of the S-FAM;

FIG. 5a is a schematic diagram of the S-FAM as a flow regulator;

FIG. 5b is a schematic diagram of another example of the S-FAM as a flow regulator;

FIG. 6 is a schematic diagram of a service based architecture implementing the S-FAM; and

FIG. 7 is a schematic diagram of another example of a service based architecture implementing the S-FAM.

### DETAILED DESCRIPTION

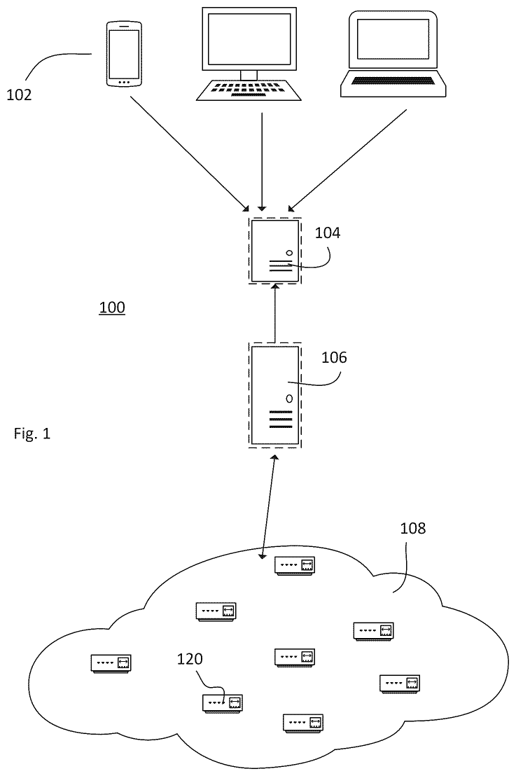

For convenience, like numerals in the description refer to like structures in the drawings. Referring to FIG. 1, a schematic drawing of a service feasibility assessment system is illustrated generally by numeral 100. The system includes one or more clients 102, a service feasibility assessment module (S-FAM) 104, an information collection module 106, and an AI model training environment 108. Although illustrated as separate, in some implementations, the S-FAM 104 and the information collection module 106 may be implemented on the same computing device. Further, while the S-FAM 104 and information collection module 106 are illustrated as a single module, they can also be implemented in a distributed manner across a plurality of devices.

In some implementations, the model training environment 108 comprises a centralized infrastructure including a globalized dataset. In some implementations, the model training environment 108 comprises a distributed infrastructure. In the distributed infrastructure, a plurality of the data nodes 120 are connected in a network-like structure often referred to as a knowledge sharing network (KSN). Such a structure is implemented in an attempt to enhance privacy and alleviate some of the concerns with the ever-growing magnitude of training data, model size, and compute cost.

Under a data and resource aware AI model steering (DRAAMs) concept, an AI model is made to traverse the KSN going from one data node 120 to another and is trained at each of the data nodes 120 in a sequential manner. There are many factors that contribute to the overall final model performance under the DRAAMs paradigm. Such factors include: knowledge of data network topology (e.g. data nodes relationships similar to social network graphs, or graphs in connected papers) and data availability; data age and size, data type and quality, data distribution and its variance over time, and the like; available resources (e.g. compute, power, storage) at participating nodes; node reachability, visibility, and trustworthiness; underlying network conditions.

DRAAMS employs some or all of the above noted attributes and uses its model routing engine to make decisions about selecting an optimum set or sequence of training nodes for generating a well-trained final model.

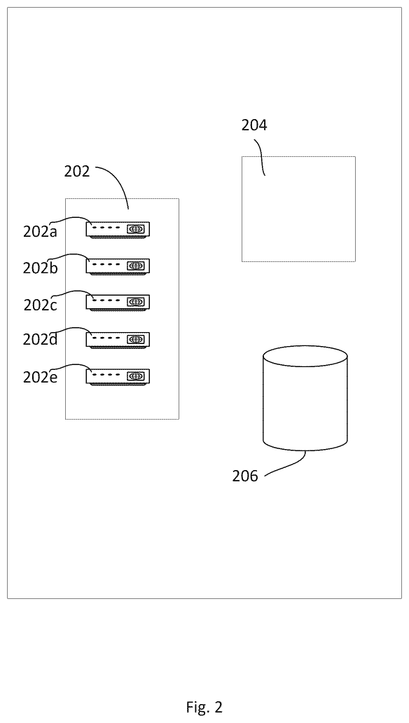

Referring to FIG. 2, a block diagram of the S-FAM 104 in greater detail is illustrated. The S-FAM 104 comprises a plurality of evaluation modules 202, a data distiller 204, and a data store 206. In some implementations, the plurality of evaluation modules 202, the data distiller 204, and the data store 206 are implemented on a single device. In some implementations, the plurality of evaluation modules 202, the data distiller 204, and the data store 206 are implemented in a distributed manner across a plurality of devices. The evaluation modules 202 include a training accuracy estimation module 202a. In some implementations, the evaluation modules 202 further include one or more of a recommendation module 202b, a monitoring service module 202c, a registry service module 202d, and an upgrade notification service module 202e. The data distiller 204 is configured to determine a relevant dataset from the global dataset and store it in the data store 206.

When submitting an AI model to the S-FAM 104 for training, each of the clients 102 submits an AI model and certain target key performance indicators (KPIs). The KPIs define a target performance for the proposed AI model to achieve by the end of the training session. As will be described, the training accuracy estimation module 202a determines whether the submitted AI model can achieve the target KPIs. Accordingly, it will be appreciated that S-FAM 104 assesses the likelihood that the AI model will achieve the KPIs after training before the AI model is allowed into the model training environment 108.

The training accuracy estimation module 202a is configured to estimate a training service feasibility assessment score, or model score, for the AI model. The model score is based, at least in part, on the relevant dataset. For example, the training accuracy estimation module 202a weighs the AI model's requirements and the client's identified target training accuracy (TTA) performance indicator against data and network resource availability. The training accuracy estimation module 202a then determines whether the model training environment 108 can satisfy model's KPIs and requirements. The training accuracy estimation module 202a also processes existing data network conditions and provides feedback in terms of performance and TTA levels that can be achieved given the current, or future predicted, state of the model training environment 108.

In some implementations, the training accuracy estimation module 202a is implemented using a zero-cost-proxy. Typically, zero-cost proxies are methods used in a neural architecture search (NAS) to predict the expected performance of different AI models given a specific dataset. The zero-cost proxy predicts each AI model's expected performance and the AI model with the best performance can then be selected. For the training accuracy estimation module 202a, the zero-cost proxy is manipulated to calculate an estimated training accuracy of the AI model submitted by the client 102 based, at least in part, on the relevant dataset. The estimated training accuracy is used to determine the model score for the AI model. Examples of zero-cost proxies include Grad_norm, SNIP, Synflow, GraSP, GradSign, Fisher, Jacob_cov, NTK_cond, Zen_score, #LR, Logdet, and NN-Mass. The training accuracy estimation module 202a can be based on any one of these proxies, or a combination of multiple proxies.

Although the training accuracy estimation module 202a is described as being implemented using a zero-cost-proxy, other known or proprietary mechanisms, such as performance prediction algorithms, look up tables, and expert knowledge, for example, may be used to determine the estimated training accuracy of the AI model submitted by the client 102.

The recommendation module 202b is configured to process and analyse information available in the model training environment 108 and generate suggested modifications to the AI model.

The monitoring service module 202c is configured to obtain live updates on the status of an AI model that has been admitted to the model training environment 108. The updates are provided as the AI model traverses the model training environment 108 and is trained.

The registry service module 202d is configured to store the AI model submitted by the client 102 in case the AI model cannot be trained to meet the target training accuracy performance indicator. In some implementations, the AI model is withheld for a certain period of time during which the request to train the AI model to the target training accuracy performance indicator may become feasible. In some implementations, the AI model is withheld until certain network conditions are met, at which point the request to train the AI model to the target training accuracy performance indicator may become feasible. The registry service module 202d can then notify the client 102 of the status change and request approval for admitting the AI model to the model training environment 108.

The upgrade notification service module 202e is configured to provide the clients 102 with notifications on the current status of any data network changes or new conditions that may affect a previously trained AI model. For example, data network changes may cause a previously trained AI model to become obsolete. Accordingly, the client may wish to submit the AI model for retraining. In some implementations, the clients 102 can instruct the S-FAM 104 to retrain the AI model in response to the notification from the upgrade notification service module 202e. In some implementations, the upgrade notification service module 202e is configured to automatically initiated a retraining of the AI model in response to detecting that the previously trained AI model may be obsolete.

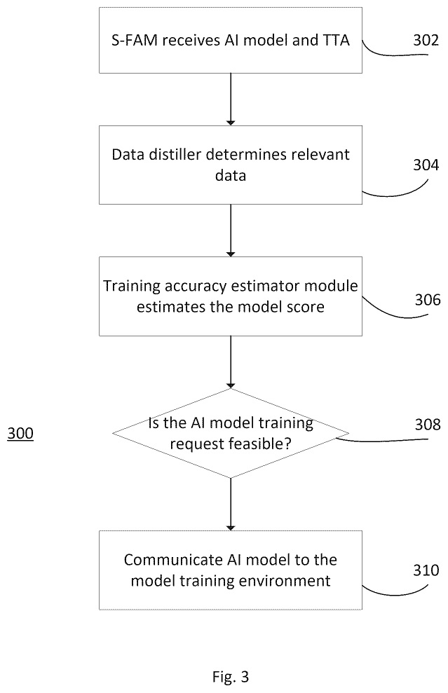

Referring to FIG. 3, a flowchart describing operation of the S-FAM 104 is illustrated generally by numeral 300. At 302, the S-FAM 104 receives one or more AI models from one or more of the clients 102. In addition to the AI models, the S-FAM 302 also receives, from the clients 102, data requirements for the AI model, and a target training accuracy performance indicator for the AI model when trained.

At 304, the data distiller 204 determines relevant data from the global dataset. The relevant data is based on the data requirements received from the clients 102. The relevant data is identified, and in some implementations collected, to make up a unique training dataset that is used to train the AI model. In some implementations, the relevant data includes all global data samples found in the global dataset. In some implementations, the relevant data includes a subset of all global data samples found in the global dataset. For example, if the data requirements indicate that the AI model is directed to a specific topic, then all global data samples from the global dataset that relate to the specific topic are identified, and in some implementations retrieved.

In some implementations, the relevant data includes the actual data retrieved from the global dataset. In some implementations, the relevant data includes data representative of the actual data retrieved from the global dataset, rather than the actual data itself. For example, some data may include sensitive or proprietary information. The owners of that information may not want it to be used for training or determining service feasibility for a new AI model.

Accordingly, in some implementations the relevant data includes anonymized data. Anonymized data is data that has its privacy protected by erasing or encrypting identifiers that connect an individual to the original data.

In some implementations, the relevant data includes synthesized or synthetic data. Synthetic data generation provides a different approach to anonymizing data while maintaining data utility. Specifically, synthetic data generation uses algorithms to create new datasets that mirror the structure and properties of the actual data retrieved from the global dataset. Generating synthetic data improves data privacy and mitigates risks of data breaches.

At 306, the training accuracy estimator module 202a is used to estimate the training service feasibility assessment score, or model score, for the AI model. The model score is based, at least in part, on the retrieved relevant data. As previously described, in some implementations, the model score is determined using a zero-cost proxy. The zero-cost proxy considers the AI model's architecture, requirements, and target KPIs. For example, along with the specific target training accuracy performance indicator, the zero-cost proxy may also consider the resources required for training, and the type of data on which the AI model is to be trained. For example, the resources required to achieve the target training accuracy performance indicator may be greater than the client 102 desires. Similarly, a dearth of the type of data on which the AI model is to be trained is a good indicator that the AI model will be unsuccessful.

The zero-cost proxy also considers available information from the underlying model training environment 108. For example, the zero-cost proxy may also consider data availability (presence, and time when it will be accessible), type, model size vs amount of data available for training, age of information, and the like. The zero-cost proxy may also consider properties of the data nodes 120, including node type, available compute, and storage resources. Yet further, the zero-cost proxy may also consider network loads within the model training environment 108.

At 308, it is determined whether the AI model training request is feasible. That is, it is determined whether the target training accuracy performance indicator can be satisfied. For example, if the model score indicates an expected training accuracy for the AI model is greater than or equal to the target training accuracy performance indicator provided by the client, then the AI model can likely be successfully trained. At 310, if the target training accuracy performance indicator can be satisfied, the AI model is communicated to the model training environment 108.

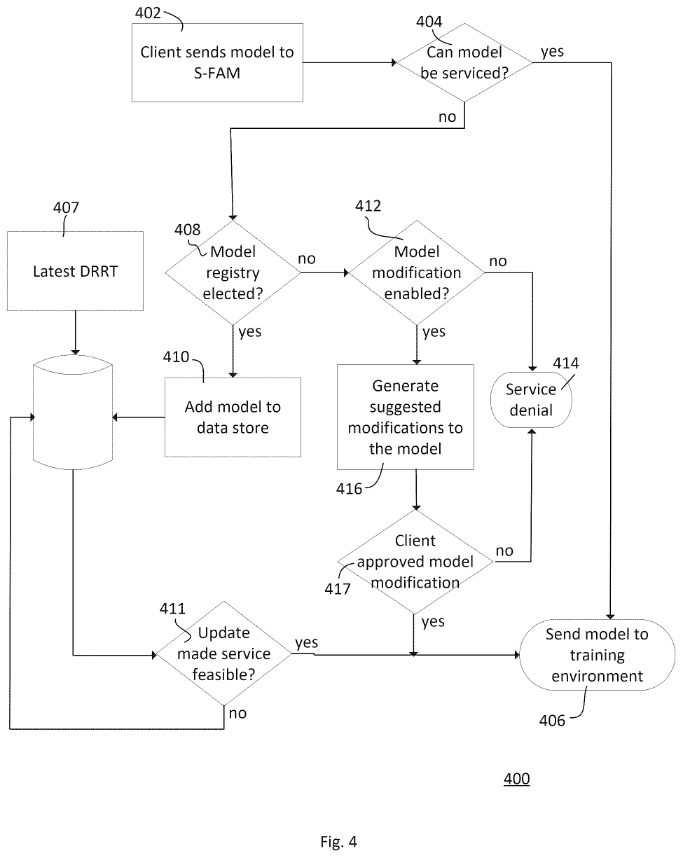

Referring to FIG. 4, a flowchart describing further operation of the S-FAM 104 is illustrated generally by numeral 400. At 402, the client sends the AI model, and desired KPIs to the S-FAM 104. At 404, the S-FAM 104 assesses service feasibility of the AI model as described with reference to FIG. 3. At 404, the S-FAM 104 determines whether the AI model request can be feasibly serviced. If the AI model request can be feasibly serviced, then at 406, the AI model is communicated to the model training environment 108 for training. At 407, the relevant data is continually being updated with the last network wide Data Resource and Reachability Topology (DRRT).

If the AI model request cannot be feasibly serviced, then at 408 the registry service module 202d determines whether the client 102 has elected to register the AI model.

If the registry service module 202d determines that the client 102 has elected to register the AI model, then at 410 the AI model is added to the data store 206. In some implementations, the registry service module 202d waits for an amount of time before retrieving the relevant data, the relevant data being updated during the waiting period. In some implementations, the amount of time is a predetermined amount of time. In some implementations, the amount of time is calculated or estimated based on the state of the network. For example, the amount of time can be based on the interval of time that the data is updated. Thus, if the data is updated every 10 minutes, the amount of time can be 10 minutes, or a multiple thereof. As another example, the amount of time can be based on the nature of the data on which the AI model is being trained. Thus, if the AI model is being trained on hurricanes, and a hurricane is predicted to occur approximately once a week, the amount of time can be one week, or a multiple thereof. The training accuracy estimation module re-processes the AI models based on the retrieved, updated relevant data to calculate a new model score.

In some implementations, the registry service module 202d identifies at least one parameter likely to improve the accuracy to which the AI model can be trained. For example, if the AI model is determined not to be feasible because the relevant data lacks a specific data type that is important to the model, then the identified parameter will be the specific data type. Once the registry service module 202d determines that the identified parameter has been updated, then the training accuracy estimation module re-processes the AI models based on the retrieved, updated relevant data to calculate a new model score.

At 411, the registry service module 202d determines, based on the new model score that the target training accuracy performance indicator can be satisfied. At 406, the AI model is communicated to the model training environment for training.

Returning to 408, if the registry service module 202d determines that the client 102 has not elected to register the AI model, then at 412 the recommendation module 202b determines whether the client 102 has elected to enable model modification. If the recommendation module 202b determines that the client 102 has not elected to enable model modification, then at 414 the service of the AI model is denied. If the recommendation module 202b determines that the client 102 has elected to enable model modification, then at 416 the recommendation module analyses information from the model training network and generates suggested modifications to the AI model to improve the likelihood that the model score will satisfy the target training accuracy performance indicator. In some implementations, the recommendation module 202b may recommend a more feasible target training accuracy performance indicator. The recommendation module 202b proposes the modifications of the AI model to the client 102 and/or the recommended target training accuracy performance indicator and, at 417, waits for client approval. If the client 102 does not approve the modifications then at 414 the service of the AI model is denied. If the client 102 approves the modifications then at 406 the modified AI model is communicated to the model training environment 108 for training. If the client 102 accepts the recommended target training accuracy performance indicator, then at 406 the AI model is communicated to the model training environment 108 for training., Once the model has been trained then at 420, the upgrade notification service module 202e monitors at least one parameter likely to affect the performance of the AI model. In response to determining that the at least one parameter will likely affect performance of the AI model beyond a predefined performance threshold, then at 406 the AI model is communicated to the model training environment 108 for retraining. In some implementations, the at least one defined parameter is monitored automatically by the upgrade service module 202e to determine if it affects operation of the AI model beyond the predefined operational threshold. In some implementations, the at least one defined parameter is updated in response to a user inquiry to determine if it affects operation of the one or more AI models beyond the predefined operational threshold.

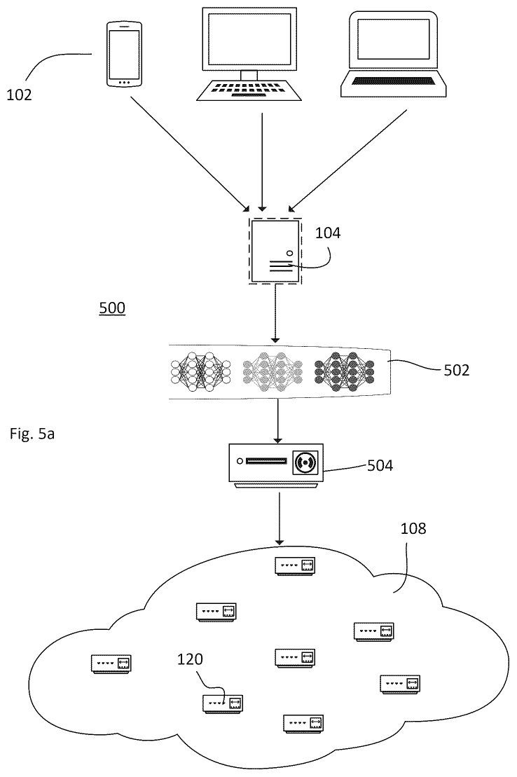

The S-FAM 104 can also be used as a model flow regulator and priority handler. Referring to FIG. 5a, a schematic diagram of the S-FAM 104 as a flow regulator is illustrated generally by number 500. The S-FAM 104 is coupled to a model engine queue 502. The model engine queue 502 is coupled to the model training environment 108 via a model routing engine 504. If the model routing engine 504 is experiencing storage and/or processing constraints, then AI models submitted to the model training environment 108 may get queued at the model engine queue 502. Providing excessive models to the model engine queue 502 can exacerbate queueing delays. Accordingly, the S-FAM 104 is responsible for regulating model access to the model engine queue 502 to minimize extensive queuing delays. The S-FAM 104 may use various distribution algorithms to handle access to the model engine queue 502 for different ones of the clients 102. For example, fairness-based methods such as round robin access could be employed. As another example, priority-based methods such as weighted access could be employed.

Referring to FIG. 5b, a schematic diagram of another example of the S-FAM 104 as a flow regulator is illustrated generally by number 550. In this example, the model engine queue 502 is empty but the network resources in the model training environment 108 are busy. Accordingly, the model routing engine 504 informs the S-FAM 104 that the model training environment 108 is busy. The model routing engine 504 may also inform the S-FAM 104 for how long the model training environment 108 is expected to remain busy. In response, the S-FAM 104 informs the clients 102 of the delay. In some implementations, the S-FAM 104 may recommend a later time for submitting the AI model for training. In some implementations, the S-FAM 104 may recommend modifications to make the AI model more suitable for the network capacity.

Accordingly, it will be appreciated that the S-FAM 104 further determines whether the model training network has capacity to train the AI model. The S-FAM 104 may withhold communication of the AI model to the model training environment 108 if the model training environment 108 lacks the capacity to train the one or more AI models. The S-FAM 104 may further prioritize access to the model training environment 108 for different ones of the one or more clients 102.

In some implementations, the S-FAM 104 can be implemented in a distributed architecture. In such an architecture, some of the features of the S-FAM 104 may be implemented on each of the data nodes 120 in the model training environment 108. For example, each of the data nodes 120 may include a data distiller 204, a data store 206, a training accuracy estimation module 202a. Each data distiller 204 can determine the relevant data, as previously described, but specifically for its corresponding data node 120. Similarly, each training accuracy estimation module 202a can determine the model score, as previously described, but specifically for its corresponding data node 120.

Accordingly, when determining the model score, rather than determine the relevant data at the S-FAM, the S-FAM 104 sends the AI model along with the required data information to all the data nodes 120 storing relevant data. The training accuracy estimation module 202a at each of the data nodes 120 storing relevant data determines a node model score. For example, each training accuracy estimation module 202a executes the zero-cost proxy on its own relevant data. Each of the node model scores is returned to the S-FAM 104. The S-FAM combines the received node model scores to determine the model score for the AI model.

In some implementations, the S-FAM 104 can be implemented as part of a 5G or 6G Service-Based Architecture (SBA). Service-Based Architectures provide a modular framework from which common applications can be deployed using components from various sources and suppliers. The 3^{rd} Generation Partnership Project (3GPP) defines an SBA in which the control plane functionality and common data repositories of a 5G network are delivered through a set of interconnected Network Functions (NFs), with each NF authorized to access the services of other NFs.

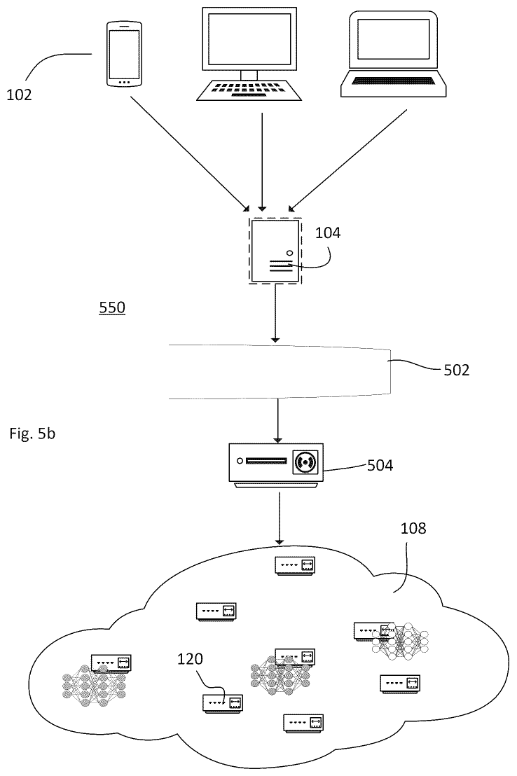

Referring to FIG. 6, an SBA-based network is illustrated generally by numeral 600. The SBA-based network 600 comprises user equipment (UE) 602, one or more base stations (gNB) 604, an access and mobility management function (AMF) 606, a session management function (SMF) 608, a user plane function (UPF) 610, a policy control function (PCF) 612, a network repository function (NRF) 614, a network analytics data function (NWDAF) 616, a service-feasibility assessment module function (S-FAMF) 618, and a plurality of data nodes 620. In this implementation, the data nodes 620 are controlled by an operator of the SBA-based network 600.

The AMF 606 receives all connection and session related information from the User Equipment. The AMF 606 is responsible for handling connection and mobility management tasks. All messages related to session management are forwarded to the SMF.

The SMF 608 is primarily responsible for interacting with the decoupled data plane, creating, updating and removing Protocol Data Unit (PDU) sessions and managing session context with the UPF 610.

The UPF 610 represents the data plane evolution of a Control and User Plane Separation (CUPS) strategy, first introduced as an extension to existing 4G/LTE Evolved Packet Cores (EPCs) by the 3GPP in their Release 14 specifications. The UPF 610 interconnects the Data Network (DN) in the 5G architecture. It is also responsible for packet routing and forwarding, packet inspections, QoS (Quality of Service) handling, and new functions are being added.

The PCF 612 plays a role in governing the behavior of the network. It acts as a control plane NF responsible for managing policies that regulate various aspects of the network. These policies encompass a wide range of functions, including quality of service (QoS), network resource allocation, authentication, mobility, security, and the like.

The NRF 614 is a central registry, holding information about every NF, which can then be shared with any NF, when required. The NRF removes the need for network configuration every time a new NF is added/removed from the network, or every time NF capacity is expanded.

The NWDAF 616 is the 3GPP standard network function that provides real-time operational intelligence in the 5G Core (5GC). It efficiently collects data from the UE, NF, operations, administration, and maintenance (OAM) systems within the 5G Core, Cloud, and Edge networks. This data can then utilized for 5G analytics.

The S-FAMF 618 is a function configured to implement the previously described S-FAM 104.

In the SBA-based network 600, the UE 602 submits its request to train an AI model to the AMF 606 via N1 interface. The AMF 606 authenticates the UE 602 and sends the request to the S-FAMF 618. S-FAMF 618 instructs the NRF 614 to locate the most up-to-date DRR topology (DRRT) of the data within the components of SBA-based network 600. The DRRT may be provided by the operator which could be supported as part of the NWDAF 616. The DRRT includes the gNBs 604 and data nodes 620, including core network components, edge compute components, and the like. Accordingly, the NRF 614 requests the DRRT from the NWDAF 616. In response the NWDAF 616 provides a DRR response to the S-FAMF 618. The S-FAMF 618 determines model admittance in a manner similar to that described for the S-FAM 104. If the AI model can be serviced, the S-FAMF 618 admits the AI model for training.

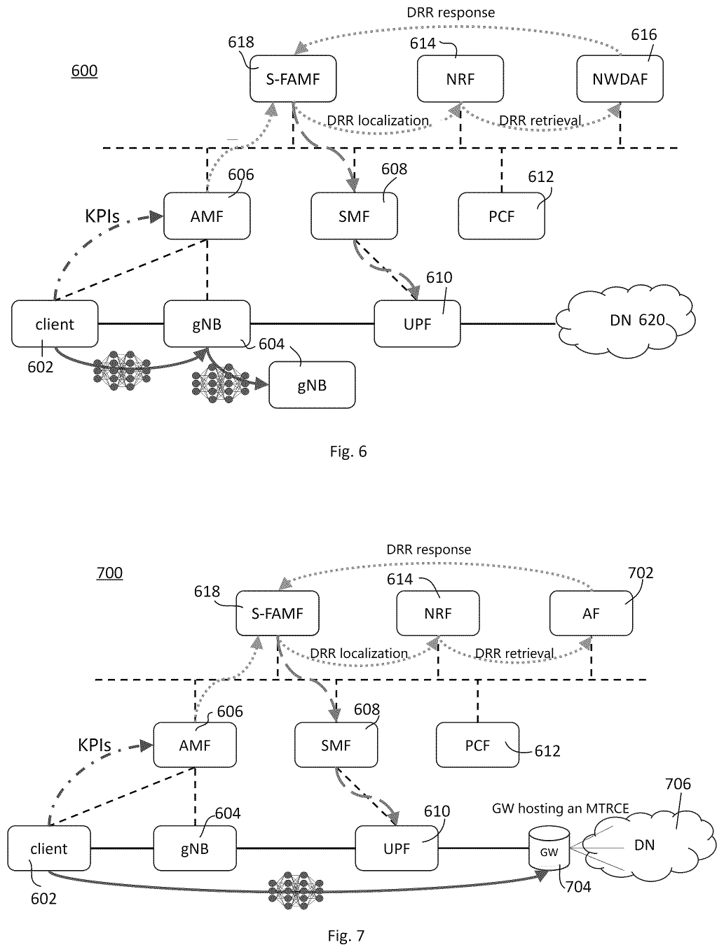

Referring to FIG. 7, another SBA-based network is illustrated generally by numeral 700. The SBA-based network 700 is similar to the SBA-based network 600 described with reference to FIG. 6. However, in this implementation, the data nodes 620 are located in a data network not controlled by the owner of the SBA-based network 700. Accordingly, the SBA-based network 700 further comprises an application function (AF) 702, a gateway 704, and a third-party data network (DN) 706.

In the SBA-based network 700, the UE 602 submits its request to train an AI model to the AMF 606 via N1 interface. The AMF 606 authenticates the UE 602 and sends the request to the S-FAMF 618. S-FAMF 618 instructs the NRF 614 to locate the most up-to-date DRR topology (DRRT). However, since the data components 620 are not within the SBA-based network 700, the AF 702 obtains the DRRT from a third party operating the third-party data network 706. Accordingly, the AF 702 requests the DRRT from the third party. The AF 702 provides the DRRT to the S-FAMF 618. The S-FAMF 618 determines model admittance in a manner similar to that described for the S-FAM 104. If the S-FAMF 618 determines that the model can be serviced, the S-FAMF instructs the SMF 608 of the DRRT for the submitted AI model. The SMF 608 configures the UPF 610 to create a session between the UE 602 and the closest gateway 704 to the third-party data network 706 corresponding to the DRRT. The AI model is sent to the gateway 704. The gateway 704 hosts a Mobile Training and Route Compute Engine (MTRCE) that handles model mobility and oversees the training process.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with”or similar expressions.

In the present disclosure, the terms “system” and “network” may be used interchangeably in embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It is clearly that a person skilled in the art can make various modifications and variations to this application without departing from the scope of this application. This application is intended to cover these modifications and variations of this application provided that they fall within the scope of protection defined by the following claims and their equivalent technologies.

What is claimed is:

1. A method comprising:
receiving at least one artificial intelligence (AI) model, data requirements for the at least one AI model, and a target training accuracy performance indicator for the at least one AI model when trained;
determining relevant data from a global dataset, the relevant data based on the received data requirements;
using a training accuracy estimation module to calculate a model score for the at least one AI model based on the relevant data, the model score representing an estimated training accuracy to which the at least one AI model can be trained;
determining, based on the model score, whether the target training accuracy performance indicator can be satisfied; and
communicating the at least one AI model to a model training environment when the target training accuracy performance indicator can be satisfied.

2. The method of claim 1 further comprising, when the target training accuracy performance indicator cannot be satisfied:
analysing information from the model training environment; and
based on the analysing, generating suggested modifications to the at least one AI model to improve the likelihood that the target training accuracy performance indicator can be satisfied.

3. The method of claim 1 further comprising, when the target training accuracy performance indicator cannot be satisfied:
waiting an amount of time;
retrieving updated relevant data from the global dataset;
using the training accuracy estimation module to re-process the at least one AI model based on the updated relevant data to calculate a new model score;
determining, based on the new model score, whether the target training accuracy performance indicator can be satisfied; and
communicating the at least one AI models to the model training environment when the target training accuracy performance indicator can be satisfied.

4. The method of claim 1 further comprising, when the target training accuracy performance indicator cannot be satisfied:
identifying at least one parameter likely to improve the accuracy to which the at least one AI model can be trained;
in response to the identified at least one parameter being updated, retrieving the relevant data, wherein the relevant data includes the updated parameter;
using the training accuracy estimation module to reprocess the at least one AI model based on the relevant data with the at least one updated parameter to calculate a new model score;
determining based on the new model score, whether the target training accuracy performance indicator can be satisfied; and
communicating the at least one AI model to the model training environment when the target training accuracy performance indicator can be satisfied.

5. The method of claim 1 further comprising, when the target training accuracy performance indicator can be satisfied:
monitoring at least one parameter likely to affect the performance of the at least one AI model; and
in response to determining the at least one parameter affects performance of the at least one AI model beyond a predefined performance threshold, re-training the at least one AI model.

6. The method of claim 5, wherein the at least one parameter is monitored automatically or updated in response to a user inquiry to determine if it affects performance of the at least one AI model beyond the predefined performance threshold.

7. The method of claim 1, wherein the relevant data comprises actual data from the global dataset or a representation of the actual data from the global dataset.

8. The method of claim 1 further comprising, when the target training accuracy performance indicator can be satisfied:
determining whether a model engine queue is experiencing at least one of storage or processing constraints, the model engine queue configured to queue AI models before entry to the model training environment; and
regulating communication of the at least one AI model to the model engine queue if the model engine queue is experiencing the at least one of storage or processing constraints.

9. The method of claim 1 further comprising prioritizing access to the model training environment for different ones of the at least one AI models.

10. The method of claim 1, wherein the training accuracy estimator comprises a zero-cost proxy and the method further comprises providing the at least one AI model to the zero-cost proxy for calculating the model score using the relevant data from the global dataset.

11. Apparatus comprising:
one or more processors; and
a non-transitory computer readable medium having stored thereon instructions which, when executed by the one or more processors, cause the apparatus to:
receive at least one artificial intelligence (AI) model, data requirements for the at least one AI model, and a target training accuracy performance indicator for the at least one AI model when trained;
determine relevant data from a global dataset, the relevant data based on the received data requirements;
use a training accuracy estimation module to calculate a model score for the at least one AI model based on the relevant data, the model score representing an estimated training accuracy to which the at least one AI model can be trained;
determine, based on the model score, whether the target training performance indicator can be satisfied; and
communicate the at least one AI model to a model training environment when the target training accuracy performance indicator can be satisfied.

12. The apparatus of claim 11 further comprising instructions that, when the target training accuracy performance indicator cannot be satisfied, cause the apparatus to:
analyse information from the model training environment; and
generate suggested modifications to the AI model to improve the likelihood that the target training accuracy performance indicator can be satisfied.

13. The apparatus of claim 11 further comprising instructions that, when the target training accuracy performance indicator cannot be satisfied, cause the apparatus to:
wait an amount of time;
retrieve updated relevant data from the global dataset;
use the training accuracy estimation module to re-process the at least one AI model based on the updated relevant data to calculate a new model score;
determine whether the new model score satisfies the target training accuracy performance indicator; and
communicate the at least one AI model to the model training environment when the new model score satisfies the target key performance indicator.

14. The apparatus of claim 11 further comprising instructions that, when the target training accuracy performance indicator cannot be satisfied, cause the apparatus to:
identify at least one parameter likely to improve the accuracy to which the at least one AI model can be trained;
in response to the identified parameter being updated, retrieve the relevant data, wherein the relevant data includes the updated parameter;
use the training accuracy estimation module to-reprocess the at least one AI model based on the relevant data with the at least one updated parameter to calculate a new model score;
determine, based on the new model score, whether the target training accuracy performance indicator can be satisfied; and
communicate the at least one AI model to the model training environment when the target training accuracy performance indicator can be satisfied.

15. The apparatus of claim 11 further comprising instructions that, when the target training accuracy performance indicator can be satisfied, cause the apparatus to:
monitor at least one parameter likely to affect the performance of the at least one AI model; and
in response to determining that the at least one parameter affects performance of the at least one AI model beyond a predefined performance threshold, re-train the at least one AI model.

16. The apparatus of claim 15, wherein the at least one parameter is monitored automatically or updated in response to a user inquiry to determine if it affects operation of the at least one AI model beyond the predefined operational threshold.

17. The apparatus of claim 11 further comprising instructions that, when the target training accuracy performance indicator can be satisfied, cause the apparatus:
determine that a model engine queue is experiencing at least one of storage or processing constraints, the model engine queue configured to queue AI models before entry to the model training environment; and
regulate communication of the at least one AI model to the engine queue if the model engine queue is experiencing the at least one of storage or processing constraints.

18. The apparatus of claim 11 further comprising prioritizing access to the model training environment for different ones of the at least one AI model.

19. The apparatus of claim 11, wherein the training accuracy estimator comprises a zero-cost proxy and the method further comprises providing the at least one AI model to the zero-cost proxy for calculating the model score using the relevant data from the global dataset.

20. The apparatus of claim 11, wherein the apparatus is a component in a service-based architecture for deploying AI-based components within a network.
